(19) United States
(12) Patent Application Publication
(10) Pub. No.: US 2023/0245109 A1
(43) Pub. Date: Aug. 3, 2023

(54) BILLING ACCOUNT AUTHENTICATION ENHANCEMENT FROM USER AUTHENTICATION CONTEXTS

(71) Applicant: T-Mobile USA, Inc., Bellevue, WA (US)

(72) Inventors: Nilay Srivastava, Sammamish, WA (US); Julia Channelle Buis, Seattle, WA (US); Ganesamoorthy K. Kuduva, Kirkland, WA (US); James Alexander Latham, Redmond, WA (US)

(21) Appl. No.: 17/592,130

(22) Filed: Feb. 3, 2022

(51) Int. Cl. G06Q 20/38; G06Q 30/04; G06Q 20/40

(52) U.S. Cl. CPC G06Q 20/3825; G06Q 30/04; G06Q 20/4012

(57) ABSTRACT

Described herein are techniques, devices, and systems for utilizing account number pins to generate enhanced tokens for user authentication. Tokens may be enhanced by a telecommunication service provider in response to the account number pins being received and validated. The enhanced tokens may be utilized for different types of processes associated with requests received from user equipment, customer care devices, and/or retail devices.

### BACKGROUND

A telecommunications provider and/or third parties can offer various services to subscribers of the telecommunications provider. Customer account security for the subscribers can be built using public standards as a framework for user authentication and user authorization. The user authentication and user authorization can be provided by tokens issued by authorization servers with the approval of the telecommunications provider. Nevertheless, the account security provided utilizing the tokens for the user authentication and user authorization may be vulnerable to fraudulent activity.

The telecommunications provider and/or the third parties can make servers (or “authentication servers”) available to provide the subscriber services. The servers can process requests (or “user requests”) received from the subscribers (e.g., user equipment users) of the telecommunications provider to pay a bill associated with their account, add a phone line to their account, buy mobile equipment, and/or buy other types of products (e.g., equipment) and/or services. The servers can manage billing accounts used to process the user requests. Individual ones of the billing accounts may be associated with multiple users, including families and businesses, and one or more of the users may have different permissions.

Various public standards, such as OAuth 2.0 and Open ID Connect (OIDC), can be utilized as a framework (or “mechanisms”) for authentication and authorization to build the customer account security. A result of an authentication and authorization procedure (e.g., an OIDC authentication and authorization procedure) is a time-limited OIDC token containing claims about the user's identity. This token identifies the user. The authentication and authorization mechanisms can be used as a way for the users to grant websites or applications access to information (e.g., website information). Methods of providing various types of information (e.g., “security credentials”) can be utilized to authenticate customer accounts.

The security credentials can include passwords. One-time password (OTP) temporary codes may be sent to customers by short messages (e.g., short message service (SMS) messages) or email messages may be used to recover customer accounts or provide additional authentication, such as multi-factor authentication (WA). Other authentication vectors such as, but not limited to, security questions may be used as MFA or for account recovery. Biometrics may be used to secure customer accounts.

The authentication server(s) may utilize authentication and authorization to provide one or more users with access to a billing account. Permissions or limitations of activity of the user(s) on the billing account are determined by the authorization. The permissions may include permissions to view data, pay bills, make purchases, etc. An account owner may configure permissions to allow or restrict certain types of access (e.g., access to view, access to modify, etc.) to the billing account for each individual user. Authorization for allowing full access by the account owner on the account to make changes, make purchases, or set permissions on other users of the account may be managed based on a billing account number personal identification number (PIN) (or “pin”). The billing account pin may be utilized by the account owner to prove that they are, in fact, the account owner.

Customer account security is a major concern as bad actors attempt to gain access to customer accounts. All methods of account security are potential vectors for fraud. Various fraudulent tactics, such as, phishing, gathering publicly available data, breaching security systems with data (e.g., re-used passwords) obtained elsewhere, friendly fraud, and the like, are frequently employed by bad actors to obtain user credentials. In particular, bad actors may attempt to gain authorization to billing accounts to make purchases of services or equipment leaving the account owner liable for payment.

Malicious techniques for fraudulently gaining access to user accounts or making purchases without customer authorization continue to increase in variety and quantity. The security credentials (e.g., passwords, OTP temporary codes, security questions, etc.) may be obtained by one or more of the fraudulent tactics (e.g., phishing, obtaining the credentials from publicly available information, etc.). If a bad actor fraudulently accesses an account belonging to an owner or manager, they may be able to obtain the corresponding permissions on the account.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1 schematically illustrates a system for generating a token that represents an authentication of a user, according to various embodiments.

FIG. 2 is a diagram illustrating example signaling for generating a token that represents an authentication of credential information, and an authentication of a billing account pin.

FIG. 3 is a diagram illustrating example signaling for generating a token that represents an authentication of credential information, an authentication of a one-time password (OTP), and an authentication of a billing account pin.

FIG. 4 is a diagram illustrating example signaling for generating a token that represents an authentication of a one-time password (OTP), and an authentication of a billing account pin.

FIG. 5 is a diagram illustrating example signaling for generating a token that represents an identification inspection, and an authentication of a billing account pin.

FIG. 6 illustrates a flowchart of an example process for generating a token that represents an authentication of a billing account pin.

### DETAILED DESCRIPTION

Described herein are techniques, devices, and systems for utilizing billing account pins to generate enhanced (or “stepped-up”) authorization tokens from user authentication to billing account authentication. Tokens (or “authorization tokens”) (or “access tokens”) can be utilized to step up user authentication and authorization to billing account authentication. The tokens can be enhanced by a telecommunication service provider (or “service provider”) (e.g., a wireless carrier) in response to the billing account pins being received and validated. The service provider can provide an authentication service to generate and enhance tokens. The enhanced tokens can be used to process user requests for account access or purchase transactions.

Initially, the service provider can establish accounts associated with its users. The accounts can include account information associated with the users. The account information can include, without limitation, a user identifier (ID) identifying the user, an account number (e.g., a billing account number (BAN)) identifying a billing account, and a phone number such (e.g., a mobile station international directory number (MSISDN)) identifying a subscription of the user with the service provider. Furthermore, the service provider can utilize the authentication service to implement a token-based authentication and authorization scheme.

Access to services provided by the service provider, and/or third parties, can be controlled based on information provided by users. For example, the service provider can utilize the user information to determine whether the users are entitled to access the services. Different types of authentication can be required for allowing access by users to corresponding types of services. Such services can include account management services, promotional services, purchase transactions, and/or services of any other type.

In existing systems, processes for determining whether users are entitled to services have security vulnerabilities. In these systems, users can make service requests. User information, such as user identity data and security credentials, can be requested from the users and utilized to determine whether to generate tokens authorizing the services. The tokens can be modified by utilizing multi-factor authentication (MFA) (e.g., second factor authentication (2FA)). Due to the proliferation of bad actors obtaining user identity data and security credentials, occurrences of fraudulent activities used to access accounts and obtain services are increasing.

The techniques, devices, and systems described herein provide reliable and robust authentication and authorization for user requests, which ensures proper operation of mobile devices and servers. By validating billing account pins to determine whether requests are received from authorized users and generating enhanced tokens, the servers can accurately verify requests by the authorized users to accounts and/or services. For instance, the servers can process purchase requests associated with enhanced tokens being validated. The servers can utilize the enhanced tokens to authorize the user to make changes on the billing account. The servers can deny access to accounts and/or services based on fraudulent information received from bad actors.

The enhanced token-based billing account authentication and authorization scheme described herein improves the security of user authentication and authorization by utilizing the enhanced token as a real-time security risk assessment mechanism. Since tokens are an existing tool within the security framework, the techniques, devices, and systems described herein may be utilized to conserve computing resources, including one or more of processing resources, memory resources, networking resources, power resources, etc. By validating enhanced tokens to determine whether to allow requests, the computing resources can be conserved for performing processes associated with authentic users. Servers can refrain from performing processes based on requests unassociated with enhanced tokens and/or requests associated with enhanced tokens not being validated.

### Illustrative Systems for Utilizing Billing Account Pins to Generate Enhanced Tokens

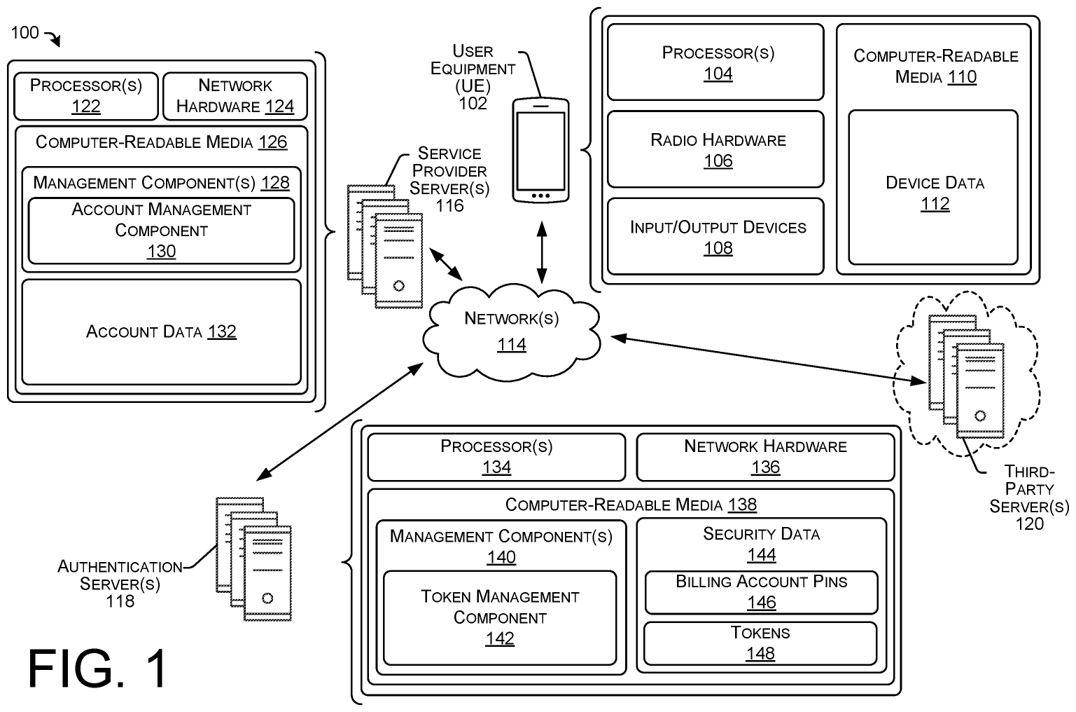

FIG. 1 schematically illustrates a system 100 for generating a token that represents an authentication of a user, according to various embodiments. The system 100 can include a user equipment (UE) 102. In some examples, the user equipment 102 can be configured with processor(s) 104, radio hardware 106, input/output devices 108, and computer-readable media 110.

In some examples, the user equipment 102 can be any suitable type of computing device configured to communicate over a wired or wireless network, including, without limitation, a mobile phone (e.g., a smart phone), a tablet computer, a laptop computer, a portable digital assistant (PDA), a wearable computer (e.g., electronic/smart glasses, a smart ewatch, fitness trackers, etc.), an IoT device, an in-vehicle (e.g., in-car) computer, a television (smart television), set-top-box (STB), desktop computer, an autonomous vehicle, a medical device, and/or the like. In accordance with various embodiments described herein, the terms “user equipment,” “wireless communication device,” “wireless device,” “communication device,” “mobile device,” “client device,” “electronic device,” and “device” may be used interchangeably herein to describe any user equipment that is capable of transmitting/receiving data wirelessly using any suitable wireless communications/data technology, protocol, or standard, such as those described elsewhere herein. A common example of a user equipment in today's world is the smart phone, but the user equipment can be implemented as any suitable type of computing device configured to communicate over a wired or wireless network, including, without limitation, a mobile phone (e.g., a smart phone/handset), a tablet computer, a laptop computer, a portable digital assistant (PDA), a wearable computer (e.g., electronic/smart glasses, a smart watch, fitness trackers, head-mounted display (FIND), etc.), an in-vehicle (e.g., in-car) computer, and/or any similar mobile device, as well as situated computing devices including, without limitation, a television (smart television), set-top-box (STB), desktop computer, and the like.

The processor(s) 104 can represent, for example, a central processing unit (CPU)-type processing unit, a graphics processing unit (GPU)-type processing unit, a Field-Programmable Gate Array (FPGA), another class of Digital Signal Processor (DSP), or other hardware logic components that can, in some instances, be driven by a CPU. For example, and without limitation, illustrative types of hardware logic components that can be used include Application-Specific Integrated Circuits (ASICs), Application-Specific Standard Products (ASSPs), System-on-a-Chip Systems (SOCs), Complex Programmable Logic Devices (CPLDs), etc. In some examples, an accelerator can represent a hybrid device, such as one from ZYLEX or ALTERA that includes a CPU course embedded in an FPGA fabric. In various embodiments, the processor(s) 104 can execute one or more components and/or processes to cause the user equipment 102 to perform a variety of functionalities, as set forth above and explained in further detail in the following disclosure. Additionally, each of the processor(s) 104 can possess its own local memory, which also can store program components, program data, and/or one or more operating systems.

The radio hardware 106 provides the user equipment 102 with wireless capabilities, such as connecting to one or more base stations associated with one or more service providers. The radio hardware 106 can include or be incorporated into processors, ASICs, programmable circuits such as FPGAs, or in other ways. In some examples, the radio hardware 106 can include radios associated with one or more radio access technologies (e.g., second generation (2G), third generation (3G), fourth generation (4G), fifth generation (5G), etc.). The user equipment 102 can include additional or alternative hardware to enable the device to access service provider(s) via additional or alternative network(s) (e.g., BLUETOOTH®, WI-FI®, etc.).

The radio hardware 106 can configure the user equipment 102 for transmitting and/or receiving data wirelessly using any suitable wireless communications and/or data technology, protocol, or standard, such as Global System for Mobile Communications (GSM), Time Division Multiple Access (TDMA), Universal Mobile Telecommunications System (UMTS), Evolution-Data Optimized (EVDO), Long Term Evolution (LTE), Advanced LTE (LTE+), New Radio (NR), Generic Access Service provider (GAN), Unlicensed Mobile Access (UMA), Code Division Multiple Access (CDMA), Orthogonal Frequency Division Multiple Access (OFDM), General Packet Radio Service (GPRS), Enhanced Data GSM Environment (EDGE), Advanced Mobile Phone System (AMPS), High Speed Packet Access (HSPA), evolved HSPA (HSPA+), Voice over internet protocol (VoIP), VoLTE, Institute of Electrical and Electronics Engineers' (IEEE) 802.1x protocols, WiMAX, Wi-Fi, Data Over Cable Service Interface Specification (DOCSIS), digital subscriber line (DSL), and/or any future internet protocol (IP)-based service provider technology or evolution of an existing IP-based service provider technology. In some examples, the user equipment 102 can be associated with radio hardware 106 available by either or any service providers with which the user equipment 102 is configured to be operable with.

The input/output device(s) 108 can be utilized by users to provide input to, and receive output from, the user equipment 102. In some examples, the input/output device(s) 108 can include a display, which can output information in a pictorial (or, in some examples, tactile) form. The display can be an electroluminescent display, liquid crystal display, a light-emitting diode display, plasma display, quantum dot display, etc. In some examples, the display can be a touch display, whereby touch of the display is an input method. In some examples, the input/output device(s) 108 can include a speaker, a microphone, a stylus, a mouse, a keyboard, or the like. For the purpose of this discussion, a user can interact with the user equipment 102 via the input/output device(s) 108. That is, a user can provide touch input, speech input, etc. to interact with the user equipment 102. Similarly, the user equipment 102 can output information to the user via presentation on a display, audible output, etc.

Depending on the exact configuration and type of the user equipment 102, the computer-readable media 110, can include computer storage media and/or communication media. The computer storage media can include volatile memory, nonvolatile memory, and/or other persistent and/or auxiliary computer storage media, removable and non-removable computer storage media implemented in any method or technology for storage of data such as computer readable instructions, data structures, program components, or other data. Computer memory is an example of computer storage media. Thus, computer storage media includes tangible and/or physical forms of media included in a device and/or hardware component that is part of a device or external to a device, including but not limited to random access memory (RAM), static random-access memory (SRAM), dynamic random-access memory (DRAM), phase change memory (PRAM), read-only memory (ROM), erasable programmable read-only memory (EPROM), electrically erasable programmable read-only memory (EEPROM), flash memory, compact disc read-only memory (CD-ROM), digital versatile discs (DVDs), optical cards or other optical storage media, miniature hard drives, memory cards, magnetic cassettes, magnetic tape, magnetic disk storage, magnetic cards or other magnetic storage devices or media, solid-state memory devices, storage arrays, service provider attached storage, storage area service providers, hosted computer storage or any other storage memory, storage device, and/or storage medium that can be used to store and maintain data for access by a computing device.

In some examples, the computer storage media can include non-transitory computer-readable media. Non-transitory computer-readable media can include volatile and nonvolatile, removable and non-removable tangible, physical media implemented in technology for storage of data, such as computer readable instructions, data structures, program components, or other data. The computer-readable media 110 is an example of non-transitory computer-readable media. Non-transitory computer-readable media include, but are not limited to, RAM, ROM, EEPROM, flash memory or other memory technology, CD-ROM, DVDs or other optical storage, magnetic cassettes, magnetic tape, magnetic disk storage or other magnetic storage devices, or any other tangible, physical medium which can be used to store the desired data and which can be accessed by the user equipment 102. Any such non-transitory computer-readable media can be part of the user equipment 102.

In contrast, communication media includes computer readable instructions, data structures, program components, or other data in a modulated data signal, such as a carrier wave, or other transmission mechanism. As defined herein, computer storage media does not include communication media.

In some examples, device data 112 can be stored on the user equipment 102, for example in the computer-readable media 110 (e.g., a database in the computer-readable media 110). However, this disclosure is not limited as such and one or more portions of the device data 112 can be stored in, alternatively or additionally to the computer-readable media 110, any of one or more other databases or one or more other data stores on the user equipment 102. The device data 112 can include, but is not limited to, identification data (e.g., an international mobile subscriber identity (IMSI), etc.) associated with the user equipment 102, an internet protocol (IP) address (e.g., an IP address utilized by the user equipment 102 to connect to the network(s) 114, as discussed below), a service provider login (e.g., an identifier including an account name and an active directory associated with an account provided by a service provider), user account data (e.g., account name, account number, etc.), service provider data (e.g., current service provider, available service providers, service(s) available via the service provider, etc.), brand data (e.g., current brand associated with the user equipment 102, etc.), context data (e.g., which application(s) are executing on the user equipment 102), capability data (e.g., which radio access technology(s) the user equipment 102 is configured to use, etc.), authentication data, and/or the like. In some examples, the device data 112 can indicate device features, including, but not limited to, radio technology (e.g., NR, LTE, UMTS, CDMA, GSM), a frequency band, voice protocol (e.g., voice on UNITS, CDMA, GSM, etc.), messaging (e.g., short message service (SMS) messaging), a speed feature (e.g., carrier aggregation (CA), 4×4 multiple input and multiple output (MIMO), or 256QAM modulation in downlink, etc.), regulatory data (e.g., E911 location, wireless emergency alerts (WEA), etc.), dual subscriber interface module (SIM) lock data, dual device unlock data, IP multimedia subsystem (IMS) services (e.g., voice over LTE (VoLTE), wi-fi calling (WFC), rich communication services (RCS), etc.), mobile hotspot data, accessibility data (e.g., text telephone (TTY), real time text (RTT), etc.), a service provider service (e.g., visual voicemail, account management, name/identification, etc.), a third-party application, a setting (e.g., access point name (APN), browser default, ringtone, splash screen, etc.), a background (e.g., identification applications, analytics applications, etc.), etc.

In some examples, the user equipment 102 can be associated with a SIM. In some examples, the SIM can configure the user equipment 102 to operate via a service provider. That is, the SIM can configure the user equipment 102 such that the user equipment 102 can communicate with other user devices via base stations and/or network devices associated with the service provider. Base stations (also known as cell sites or cell towers) can be associated with antennae and other electronic communications equipment (e.g., transceivers, digital signal processors, control electronics, a GPS receiver, etc.) to create a cell. A service provider can have multiple base stations, creating multiple cells, thereby generating a cellular network. In some examples, the SIM can be a SIM card that is insertable into the user equipment 102, an eSIM (e.g., an embedded, electronic, and/or enhanced SIM), an iSIM (e.g., an integrated SIM), etc.), or any other type of electrical component or electrical circuit (e.g., an integrated circuit, a portable memory chip, or an integrated memory chip).

In some examples, the SIM can enable the user equipment 102 to access services provided via a core network associated with the service provider. In some examples, such services can include IMS-based services, including but not limited to, telephony services, emergency services (e.g., E911), gaming services, instant messaging services, presence services, video conferencing services, social networking and sharing services, location-based services, push-to-talk services, and so on. The SIM can receive, store, update, and/or manage the wireless subscriber information, such as a mobile station international subscriber director number (MSISDN) (e.g., a phone number of a user associated with the user equipment 102) and/or an internet protocol (IP) multimedia subsystem (IMS) public user identity (IMPU)).

In some examples, the user equipment 102 can communicate with via one or more networks 114, with one or more servers (or “service provider server(s)”) 116 (e.g., a network node) associated with the service provider, one or more servers (or “authentication server(s)”) (e.g., authentication server 118) associated with authentication, and one or more servers (or “third-party server(s)”) 120 associated with a third-party. In some examples, the network(s) 114 can include access network(s) (e.g., network(s) that connect users (e.g., user equipment associated therewith) to a service provider (e.g., a telecommunications service provider), provider network(s), a core network (which, in some examples can be a “carrier” network) (e.g., that connects one or more other service providers to one another), etc.

In some examples, such network(s) 114 can comprise one or more cellular networks, the Internet, and/or the like. For example, the network(s) 114 may represent and/or include a fifth generation (5G) core network. In some examples, the network(s) 114 may represent and/or include an Internet Protocol Multimedia Subsystem (IMS) core network. The IMS core is an architectural framework defined by the 3GPP for delivering Internet Protocol (IP) multimedia to UEs. In some examples, the network(s) 114 may include one or more access networks, including radio access networks (RANs) and/or radio access technologies (RATs). In general, the network(s) 114 can be capable of transmitting/receiving data wirelessly using any suitable wireless communications/data technology, protocol, or standard, such as Global System for Mobile Communications (GSM), Time Division Multiple Access (TDMA), Universal Mobile Telecommunications System (UMTS), Evolution-Data Optimized (EVDO), Long Term Evolution (LTE), Advanced LTE (LTE+), Generic Access Network (GAN), Unlicensed Mobile Access (UMA), Code Division Multiple Access (CDMA), Orthogonal Frequency Division Multiple Access (OFDM), General Packet Radio Service (GPRS), Enhanced Data GSM Environment (EDGE), Advanced Mobile Phone System (AMPS), High Speed Packet Access (HSPA), evolved HSPA (HSPA+), Voice over IP (VoIP), Voice over LTE (VoLTE), Voice over NR (VoNR), IEEE 802.1x protocols, WiMAX, Wi-Fi, Data Over Cable Service Interface Specification (DOCSIS), digital subscriber line (DSL), and/or any future IP-based network technology or evolution of an existing IP-based network technology, including 5G NR networking protocols, and/or existing or legacy network technology, such as second generation (2G), third generation (3G), fourth generation (4G), including circuit-switched networking protocols and/or packet-switched networking protocols.

The service provider server(s) 116 can include one or more components, such as one or more processor 122, network hardware 124, and/or computer-readable media 126. The processor(s) 122 can comprise the same or similar structure and/or function as the processor(s) 104 described above. The computer-readable media 126, can include computer storage media and/or communication media, both of which are described above with reference to the computer-readable media 110. That is, the computer-readable media 126 can have the same or similar structure and/or function as the computer-readable media 110 described above.

The network hardware 124 can provide wired or wireless networking capabilities to the service provider server(s) 116. For example, the network hardware 124 can be utilized for any of the message(s) and/or information received by, and/or transmitted to, the service provider server(s) 116. The network hardware 124 can include or be incorporated into processors, ASICs, programmable circuits such as FPGAs, or in other ways.

The computer-readable media 126 can store one or more management components 128, which can include an account management component 130. The account management component 130 can utilize account data 132 to manage access (or “user account related access”) to information associated with the user accounts. The account data 132 can include data that is received from the user equipment 102, and that is the same as one or more portions of the device data 112. The account data 132 can include data associated with any number of user accounts.

The account data 132 can include data associated with users and/or billing accounts. The data (or “user identity data”) (e.g., user identity elements) associated with the user identities and/or the billing accounts can include usernames, user identifiers, MSISDNs, and/or billing account numbers (BANs), and/or any other types of identifiers associated with the users. The information associated with the user accounts can include one or more of billing plan information, payment methods, caller tunes, etc.

The account data 132 can include data (or “manual identity validation data”) (e.g., manual identity validation elements) associated with manual identity validation (or “physical identity validation”). The manual identity validation elements can be utilized to indicate successful validation of manual identities. By way of example, a manual identity validation element can include a flag set as true, based on successful manual validation of an identity of a user.

The account data 132 can include data (or “supplemental identity validation data”) (e.g., supplemental identity validation elements) associated with supplemental identity validation performed by customer service. The supplemental identity validation elements can be utilized to indicate successful validation of identities by the customer service representatives. By way of example, a supplemental identity validation element can include a flag set as true, based on a customer service representative performing successful validation of an identity of a user.

The account management component 130 can manage requests authenticated with tokens. In some examples, the account management component 130 can determine a request is authenticated based on a token (e.g., an enhanced token) that identifies the user and a billing account of the user. In those examples, the account management component 130 can verify that the user successfully stepped-up their authentication to authorize the request. Verification that the user successfully stepped-up their authentication to authorize the request can be performed utilizing the enhanced token.

The authentication server 118 can include one or more components, such as one or more processor(s) 134, network hardware 136, and computer-readable media 138. The processor(s) 134 can comprise the same or similar structure and/or function as the processor(s) 104 described above. The computer-readable media 138, can include computer storage media and/or communication media, both of which are described above with reference to the computer-readable media 110. That is, the computer-readable media 138 can have the same or similar structure and/or function as the computer-readable media 110 described above.

The network hardware 136 can provide wired or wireless networking capabilities to the service provider server(s) 116. For example, the network hardware 136 can be utilized for any of the message(s) and/or information received by, and/or transmitted to, the service provider server(s) 116. The network hardware 136 can include or be incorporated into processors, ASICs, programmable circuits such as FPGAs, or in other ways.

The computer-readable media 126 can store one or more management components 140, which can include a token management component 142. The token management component 142 can store security data 144, including billing account pins 146 and tokens, including tokens (or “enhanced tokens”) 148 that have been stepped-up with respect to their authentication level. The token management component 142 can generate tokens, which can include the tokens 148 that are generated based on billing account pins 146. The token management component 142 can determine whether to generate the tokens 148 based on security credentials (or “credentials”) (or “user credentials”) (e.g., security elements (or “security credential elements”) and “enhanced security elements (or “enhanced security credential elements”)) in the security data 144. The security credential elements can include one or more of passwords (or “user passwords”), answers to security questions, and multi factor authentication (MFA) elements (e.g., biometrics data elements, one-time passwords (OTPs), etc.)). The enhanced security credential elements can include BAN personal identification number (PINs) (or “pins”).

The security credentials can be utilized as part of token generation for digital authentication. The usernames and passwords can be utilized to validate an identity of the user. The MFA elements can be utilized as additional proof of user authentication. The billing account pins 146 can be utilized as proof of account ownership authorization.

The tokens 148 can include data (or “token data”) associated with the tokens 148. The token data can include information associated with data received by the token management component 142 and utilized to generate, modify, and/or enhance the tokens. In some examples, the token data can include information associated with one or more portions of the data utilized to generate the corresponding tokens 148. In those examples, the token data can include the user identity data (e.g., one or more of the user identity elements), account data (e.g., any portions of the account data 132), permission data, as well as information about the authentication and authorization that took place. By way of example, the information about the authentication and authorization that took place can include information indicating successful validation of one or more security credentials received from the user equipment 102.

The tokens 148 can be managed on a temporary basis. The tokens 148 can be utilized for periods of time and then discarded. By way of example, a token 148 can be discarded based on an amount of time between generation of the token and the current time meeting or exceeding a threshold amount of time (e.g., 1 hour). Authentication timestamps can be used to indicate a point in time at which the tokens 148 are generated. Expiration timestamps can be used to indicate a point in time at which the tokens 148 expire. Although the threshold amount of time can be 1 hour, as discussed above in the current disclosure, it is not limited as such. In some examples, the threshold amount of time during which any of the tokens 148 is available can be any amount of time (e.g., 30 minutes, 45 minutes, 1 hour, 5 hours, 1 day, 1 week, etc.).

In some examples, the tokens 148 can be utilized to establish a relationship between the user's browser and the token 148. The relationship can be established via generating a relationship identifier indicating the user's browser is associated with the token 148. In some examples, the tokens 148 can be stored (e.g., temporarily stored) along with data associated with the user's browser, such as on one or more server(s) that store the user's browser.

The tokens 148 can include the information (or “token information”) associated with authentication and authorization. By way of example, the token information can include the identity (e.g., one or more user identity elements) of the user and one or more types of user authentication (e.g., types of security credentials used to authenticate the user).

Token information can include the identity (e.g., the BAN) of the billing account, permissions of the billing account, levels of authorization, security parameters, and/or one or more types of billing account authentication. The token information can include a billing account attribute indicating the billing account pin 146 is associated with the authorized user. The token information can also include an authentication timestamp of the token 148, an expiration timestamp of the token 148, and other elements (e.g., string values used to associate communication sessions with the tokens, authentication context class reference (ACR) values identifying authentication context classes that authentication performed satisfied, authentication methods reference (AMR) values identifying authentication methods used in authentication, etc.) used, and possibly required, for security and validity of the token 148.

By providing tokens 148 with the token information (e.g., information, which, in some examples, can include the information about one or more of the user), authentication, billing account and permissions, access to information and/or performing of processes associated with the user accounts can be allowed. The access to information and/or performing of processes associated with the user accounts can be allowed based on the tokens 148 providing corresponding levels of security (or “levels of authorization”) (e.g., authorization via a token based on security credential(s), modified authorization via a modified token based on security credential(s) and MFA element(s), or enhanced authorization (or “billing account authorization”) via an enhanced token (e.g., the token 148) based on security credential(s), MFA element(s), and the account pin) requested by the user equipment 102 and provided by the token management component 142.

In some examples, the level of security required and achieved by the user may have resulted in a token that provides one or more entitlements. In those examples, the entitlement(s) can include the token being utilized to allow a user to view their bill and/or to process a payment using stored payment information. The token can indicate the authorization to allow the user to view their bill and/or to process the payment using the stored payment information.

In some examples, the level of security required by the user can be higher. The user can step-up the token with additional authentication to an enhanced token (e.g., a token 148) (or “enhanced authorization token”) associated with one or more entitlements. In those examples, the entitlement(s) can include the token 148 being utilized to indicate authorization of purchases associated with one or more products and/or one or more services. The token 148 can indicate the authorization of the purchases associated with the product(s) and/or the service(s)

The security data utilized by the user (e.g., passwords, billing account pins, OTPs, biometrics, manual identity validation values, etc.) can be computed for authentication or higher levels of MFA and billing authentication. These authentication can be indicated in the tokens used by the service provider server(s) 116 to determine whether the user is entitled to the request.

The third-party server(s) 120 can include one or more components that are similar to corresponding component(s) of any other servers (e.g., the service provider server(s) 116), as discussed above. In some examples, the third-party server(s) 120 can include component(s), such as processor(s), network hardware, and computer-readable media that are the same or similar structure and/or have the same or similar functions as the processor(s) 134, the network hardware 136, and the computer-readable media 138, respectively, described above.

Although the third-party server(s) 120 can include component(s), as discussed above in the current disclosure, it is not limited thereby. The third-party server(s) 120 can include any combination of the similar component(s) and/or other component(s).

Although the term “user” is utilized with respect to the user equipment as discussed above in this disclosure, it is not limited as such. In some examples, the term “user” can be utilized to refer to a user of the user equipment, an operator associated with the service provider or the third-party, a customer care representative, a retail representative, etc.

Although a user equipment (e.g., the user equipment 102) is utilized by the user, as discussed above in this disclosure, it is not limited as such. In some examples, any type of computing device (e.g., a personal computer configured to operate a browser used to display a website, such as a website associated with the service provider), can be utilized in a similar way as the user equipment to implement any of the techniques discussed throughout this disclosure.

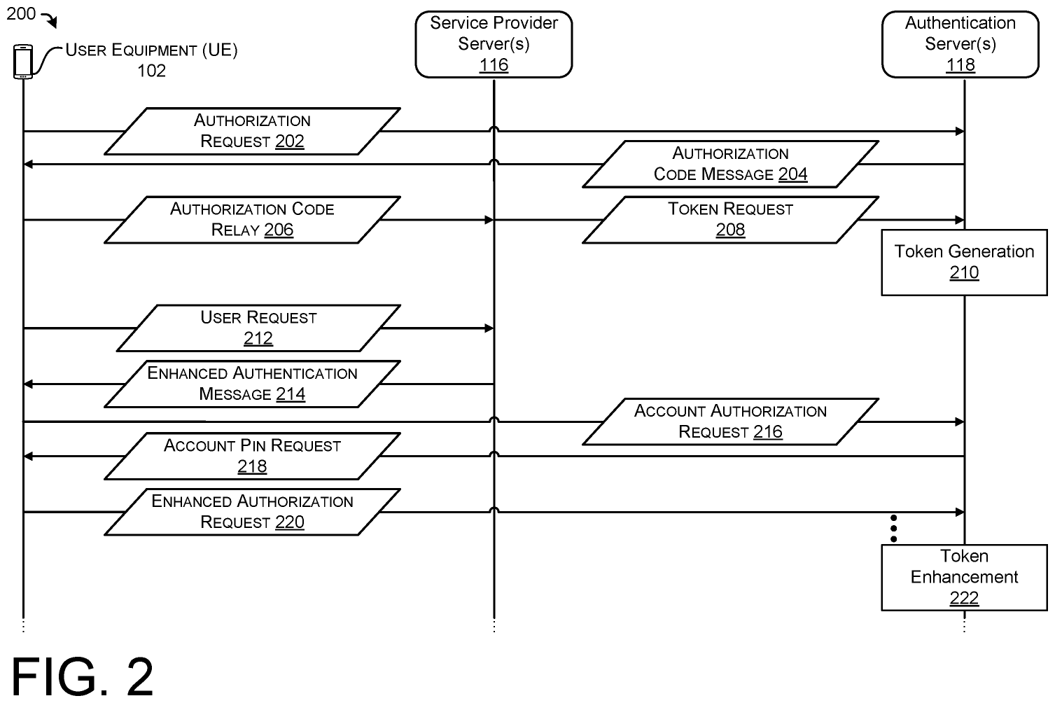

FIG. 2 is a diagram illustrating example signaling 200 for generating a token that represents an authentication of credential information, and an authentication of a billing account pin. The example signaling 200 can include signaling between a user equipment (UE) (e.g., the user equipment 102, as discussed above with reference to FIG. 1), one or more service provider servers (e.g., the service provider server(s) 116, as discussed above with reference to FIG. 1), and one or more authentication servers (e.g., the authentication server 118, as discussed above with reference to FIG. 1).

The user equipment 102 can transmit an authorization request 202 based on user data received via one or more selections indicated by user input. User input associated with the authorization request 202 can be provided by a user and to the user equipment 102. The user input provided by the user can be received via the selection(s) based on information (or “authorization request information”) output by the user equipment 102. In some examples, the authentication request information can be output by the user equipment 102 to the authentication server 118, which have not previously received a token associated with the user.

The authorization request 202 can be transmitted based on user input that is received using any type of software content (e.g., authorization request software content) processed by the user equipment 102. The software content can include a program (e.g., a web browser), an application (e.g., a mobile application, etc.), or any other type of software content. In some examples, the authorization request software content can be processed by the user equipment 102 utilizing information (or “service provider software content information”) received from the service provider server(s) 116. In some examples, the authorization request 202 can be processed as part of an account login process associated with the user.

The authorization request 202 can include various types of information (or “authorization request information”) transmitted in a signal (e.g., request). The authorization request 202 can include the user data, such as user identity data and/or security credential data. In some examples, the authorization request 202 can include one or more elements of the user identity data and/or the security credential data. In those examples, the user identity data can include one or more user identity elements, including a username. The security credential data can include one or more credential elements, including a password, OTP, or biometric data. The authorization request 202 can include authorization parameters (e.g., parameters that define a context (or “authorization context”) of the request) associated with one or more portions of the user data. The authorization request 202 can be transmitted by the user equipment 102 as part of the account login process. The authorization context can indicate a level of authorization requested by the user equipment 102.

The authentication server 118 can verify the user identity, and validate the credentials and the authorization context indicated by the authorization request 202. Validating the credentials and/or the authorization context, such as to determine whether the authorization request 202 is valid, can include validating the corresponding parameter(s). In some examples, the user identity can be verified by utilizing the user identity data and/or the security data 144 to verify the user identity data received in the authorization request 202. In some examples, the credentials can be validated by utilizing the security data 144 to validate the security elements received in the authorization request 202. The authentication server 118 can complete authorization, or verify completion of the authorization (e.g., verify completion of the authorization if it was already completed as part of the same session) at the level of authorization requested by the user equipment 102. If the authorization request 202 is valid, the authentication server(s) 118 can generate an authorization code.

The authentication server 118 can transmit, in an authorization code message 204, the authorization code to the user equipment 102. The user equipment 102 can forward, in an authorization code relay 206, the authorization code to the service provider server(s) 116. In some examples, the authorization code relay 206 can be transmitted by the user equipment 102 and to the service provider server(s) 116 as part of an HTTP redirect.

The service provider server(s) 116 can transmit a token request (or “an access token request”) 208 including the authorization code. The token request 208 can be transmitted based on the service provider server(s) 116 determining the authorization code is received in the authorization code relay 206. In some examples, the service provider server(s) 116 can determine to transmit the token request 208 based on the authorization code being validated by the service provider server(s) 116. In some examples, the HTTP redirect can include forwarding the authorization code relay 206 as the token request 208.

In some examples, the authentication server 118 can transmit a response (or “unsuccessful authorization response”). The unsuccessful authorization response can be transmitted to the user equipment 102. In some examples, the authentication server 118 can transmit the unsuccessful authorization response based on the user identity not being verified, the credentials not being validated, and/or the authorization context not being validated. In those examples, the unsuccessful authorization response can be transmitted based on the authorization request 202.

In some examples, the authentication server 118 can transmit the unsuccessful authorization response based on the authorization code not being validated. In those examples, the unsuccessful authorization response can be transmitted based on the token request 208. The unsuccessful authorization response can be utilized by the user equipment 102 to output information to indicate the unsuccessful authorization, to receive user data (e.g., new user data received via one or more additional selections indicated by user input), and to transmit an authorization request (e.g., a second authorization request). The second authorization request can be utilized in a similar way as any type of authorization request (e.g., the authorization request 202) to implement any of the techniques discussed throughout this disclosure. The process can continue with any number of authorization requests until the user identity is verified, and the credentials and/or the authorization context are validated.

The authentication server(s) 118 (e.g., the token management component 142) can perform a token generation process (or “token generation”) 210 based on the token request 208. The token generation 210 can be utilized to generate a token (or “access token” (or “user authentication token”) based on the authorization code in the token request 208. The token can include one or more data parameters (or “authorization parameter(s)”) indicating the user identity, a type of user authentication, a level of user authorization, and security parameters related to the authentication and authorization of the user. The token can be signed by the authentication server(s) 118 for security. The authentication server(s) 118 can transmit the token (e.g., the signed token) to the service provider server(s) 116.

In some examples, the service provider server(s) 116 can receive a request (or “user request”) 212 transmitted by the user equipment 102. The user request 212 can be utilized to determine whether to authorize output of account information, processing of payments, and/or purchasing of one or more products and/or one or more services. The service provider server(s) 116 can utilize the token generated via the token generation 210 to process one or more user requests (e.g., the user request 212). The user request 212 can be transmitted by the user equipment 102. Information (or “user request information”) can be included in the user request 212, based on user data (or “additional user data”) received via one or more selections indicated by user input to the user equipment 102. The additional user data can be received based on information output by the user equipment 102, the information being utilizable by the user to request output of account information, request processing of payments, and/or request purchasing of one or more products and/or one or more services.

The user payments indicated in the user request information can include payments based on a bill associated with the user account. The user payments can be processed based on the user having previously provided payment information (e.g., credit card information (e.g., one or more of a number, expiration date, and security code of a credit card), bank account information (e.g., a bank account number, a bank routing number), etc.), and previously authorizing the payment information to be utilized for user requests (e.g., the user request 212) to the service provider server(s) 116.

The service(s) and/or the product(s) indicated in the user request information can include various types of service(s) and/or product(s), such as an online/digital purchase, an account management request, etc. By way of example, the user request information can include purchase information, service plan information, account information, and the like. In some examples, the purchase information can indicate a payment item (e.g., a credit card being added to the account, a credit card that was previously added to the account and stored with the service provider, etc.) associated with a request for payment of a bill. The service plan information can include information indicating changes requested for the service plan (e.g., a decrease in a service plan, etc.). The account information can include information indicating changes requested for the account, such as to update payment information in the account (e.g., credit card information indicating a credit card that has been requested to be added to the account, the credit card information being associated with the same information (e.g., a same name and a same address) as for the information (e.g., the name and address, respectively) associated with the account, etc.).

The service provider server(s) 116 can transmit an authentication message (or “enhanced authentication required message”) 214 to the user equipment 102. The enhanced authentication message 214 can be utilized by the user equipment 102 to determine whether to request enhanced authentication (e.g., billing account authorization). The service provider server(s) 116 can transmit the enhanced authentication message 214 based on determining the token additional authentication is required. The enhanced authentication message 214 can indicate to the user equipment 102 that authentication is required for processing the user request 212. In some examples, the enhanced authentication message 214 can indicate to the user equipment 102 that the authentication required for processing the user request 212 is enhanced authentication.

The user equipment 102 can transmit an account authorization request (or “billing account authorization request”) 216 to the authentication server 118. In some examples, the billing account authorization request 216 can be transmitted based on the enhanced authentication message 214. The billing account authorization request 216 can include one or more of the authorization parameter(s) provided by the user equipment 102. In some examples, the user equipment 102 can determine to request, based on the enhanced authentication message 214 and via the billing account authorization request 216, the token 148 to be generated (e.g., generation of the token 148 by validation of the credential elements and the enhanced credential elements). In those examples, the authentication server 118 can determine that MFA does not need to be utilized to generate the token 148, based on the information in the billing account authorization request 216 and/or the user request 212 (e.g., the user request information in the user request 212 not indicating that MFA is required).

Different levels of security associated with account data access or purchase transactions can be utilized to provide customized security protection. Because a potential severity of harm due to fraudulent acts by bad actors that are attempting to obtain access to an account may be less than a potential severity of harm due to fraudulent acts by bad actors that are attempting to purchase service(s) and/or product(s), refraining from requiring validation of a billing account pin until the user request 212 is received provides an increased level of convenience for users to access account data. The user does not have to provide the account pin until a time at which the user is ready to make a purchase, improving security when required, and potentially reducing user friction when not required.

The authentication server 118 can transmit an account pin request 218 based on the billing account authorization request 216. The account pin request 218 can be transmitted to the user equipment 102.

The user equipment 102 can process the account pin request 218 and output (e.g., display/present), via a display, information to request input of an account pin (e.g., a group of characters (e.g., 6-15 numbers, 25-30 numbers, etc.). In some examples, the output of the information to request input of the billing account pin can be performed by the user equipment 102 prior to the user equipment 102 receiving the billing account authorization request 218. In some examples, the user equipment 102 can, additionally or alternatively to outputting any other type of information (e.g., the information utilizable by the user to request the output of the account information, request the processing of payments, and/or request the purchasing of one or more products and/or one or more services), output the information (or “account pin request information”) to request the account pin.

The account pin request information can be presented based on the user equipment 102 processing software content (or “account pin processing software content”) to request the account pin. The account pin processing software content may be processed by the user equipment 102 utilizing service provider software content information. The account pin processing software content may be processed, based on the account pin request 218. The user equipment 102 can receive data (e.g., the account pin), via user input indicating one or more selections of the user.

The user equipment 102 can transmit an enhanced authorization request (or “billing account pin response”) 220 to the authentication server(s) 118. The enhanced authorization request 220 can include the billing account pin received by the user equipment 102 via input from the user.

The authentication server(s) 118 can generate an enhanced authorization code, based on the enhanced authorization request 220 being valid. In some examples, the authentication server(s) 118 can verify successful validation of the data (e.g., the account pin) received from the user equipment 102, and the access token generated via the token generation 210. In those examples, the enhanced authorization code can be generated based on the access token and the authorization context received in the authorization request 202 being valid, and the account pin received in the enhanced authorization request 220 being valid (e.g., the enhanced authorization request 220 being valid). The account pin received from the user equipment 102 can be determined as being valid based on the account pin received from the user equipment 102 matching, or not matching an account pin (or “billing account pin”) 146 provided by the user at the creation of the account) in the security data 144.

The account pin 146 associated with the user account (or “billing account”) can be retrieved from a database (e.g., a database of the authentication server(s) 118 that includes the billing account pins 146). The account pin 146 associated with the account can be retrieved utilizing one or more portions (e.g., identity elements of the user and/or the billing account) of the authorization request information received in the authorization request 202.

The authentication server(s) 118 can generate and transmit an enhanced authorization code message to the user equipment 102. The user equipment 102 can utilize the enhanced authorization code message to forward the enhanced authorization code to the service provider server(s) 116. The enhanced authorization code can be forwarded to the service provider server(s) 116, in an enhanced authorization code relay. The enhanced authorization code relay can be utilized by the user equipment 102 to forward the enhanced authorization code to the service provider server(s) 116, possibly as part of an HTTP redirect. The service provider server(s) 116 can store the enhanced authorization code. The service provider server(s) 116 can transmit an enhanced token request (or “token enhancement request”) with the enhanced authorization code, to the authentication server(s) 118 based on the enhanced authorization code relay. In some examples, the HTTP redirect can include forwarding the enhanced authorization relay as the enhanced token request.

The enhanced authorization code can be utilized to perform a token enhancement process (or “token enhancement”) 222. The token enhancement 222 can be performed based on the enhanced token request. The token enhancement 222 can be utilized to generate an enhanced token (e.g., the token 148), in a similar way as the authorization code utilized to generate the access token via the token request 208, as discussed above, except by utilizing the account pin along with the access token. The token enhancement 222 can be performed based on the access token and the account pin being validated. The token enhancement 222 can be performed based on the enhanced authorization code being received in the enhanced token request, and being validated. In some examples, the token enhancement 222 can be performed to replace, and/or enhance, the access token generated via the token generation 210.

The token 148 can include one or more data parameters (or “authorization parameter(s)”) (e.g., parameter(s) received from the user equipment 102), individual ones of the authorization parameter(s) indicating the user identity, types of user authentication, types of billing account authentication, the level of user authorization, the level of billing account authorization (e.g., authorization based on verification of the account pin), and security parameters related to the authentication and authorization of the user. The token 148 can include token information, including a billing account attribute indicating the account pin is associated with the authorized user. The token 148 can be signed by the authentication server(s) 118 for security. The authentication server(s) 118 can transmit the token 148 (e.g., the signed token) to the service provider server(s) 116. The level of user and billing account authorization can be associated with the user request 212.

In some examples, the authentication server(s) 118 can transmit a response (or “invalid authorization response”) based on the corresponding element(s) in the enhanced authorization request 220 not being validated. The invalid authorization data response can be utilized by the user equipment 102 to output information to indicate the corresponding element(s) not being validated, and to transmit new data (e.g., corrected billing account pin). A second enhanced authorization request can be transmitted to, and processed by, authentication server(s) 118, in a similar way as the enhanced authorization request 220. The process can continue until an enhanced authorization request is received and validated.

In some examples, the enhanced token (e.g., a token 148 of a first type), which is signed by the authentication server(s) 118, can be utilized by the service provider server(s) 116 to authorize the user request 212. The token 148 can be utilized to allow (e.g., authorize) account information to be output by the user equipment 102, processing of payments, and/or purchasing of one or more products and/or one or more services. This can be performed by the authentication server(s) 118 based on the authentication server(s) 118 determining generation of the token 148 was based on the credential elements and the enhanced credential element (e.g., the account pin). The token 148 can be generated for authorizing the user request 212 without requiring validation of MFA.

The purchasing of one or more products and/or one or more services allowed by the authentication server(s) 118 can be based on information provided to the user equipment 102 by the service provider server(s) 116 or the third party server(s) 120. The purchasing of one or more products and/or one or more services can be allowed (e.g., authorized) in a same session being utilized by the user equipment 102. The token 148 can be passed around to, and utilized by, one or more computing devices (e.g., the service provider server(s) 116, the third-party server(s) 120, etc.), to complete purchases, etc., until the token 148 expires or is revoked by the authentication server(s) 118.

Although the terms “token generation,” “token modification,” and “token enhancement” are utilized with respect to different functions, as discussed above in the current disclosure, it is not limited as such. These terms are utilized merely for simplicity and clarity. The terms “token generation,” “token modification” and “token enhancement” may be referred to as functions to generate tokens, which may possibly be performed utilizing one or more previously generated tokens. The term “token enhancement” may be further referred to as “token generation” or “token modification” utilizing billing account pins.

Although the terms “token,” “modified token,” and “enhanced token” are utilized with respect to different types of tokens, as discussed above in the current disclosure, it is not limited as such. These terms are utilized merely for simplicity and clarity. The terms “token,” “modified token” and “enhanced token” may be referred to as tokens, indicating data of one or more types being validated. The term “enhanced token” may be further referred to as a token indicating a billing account pin being validated.

Although the username is utilized to generate the tokens as discussed in the current disclosure, it is not limited as such. Any of one or more other user identity elements (e.g., an MSISDN, a user identifier, etc.), may be utilized instead of the username in any techniques discussed throughout the disclosure.

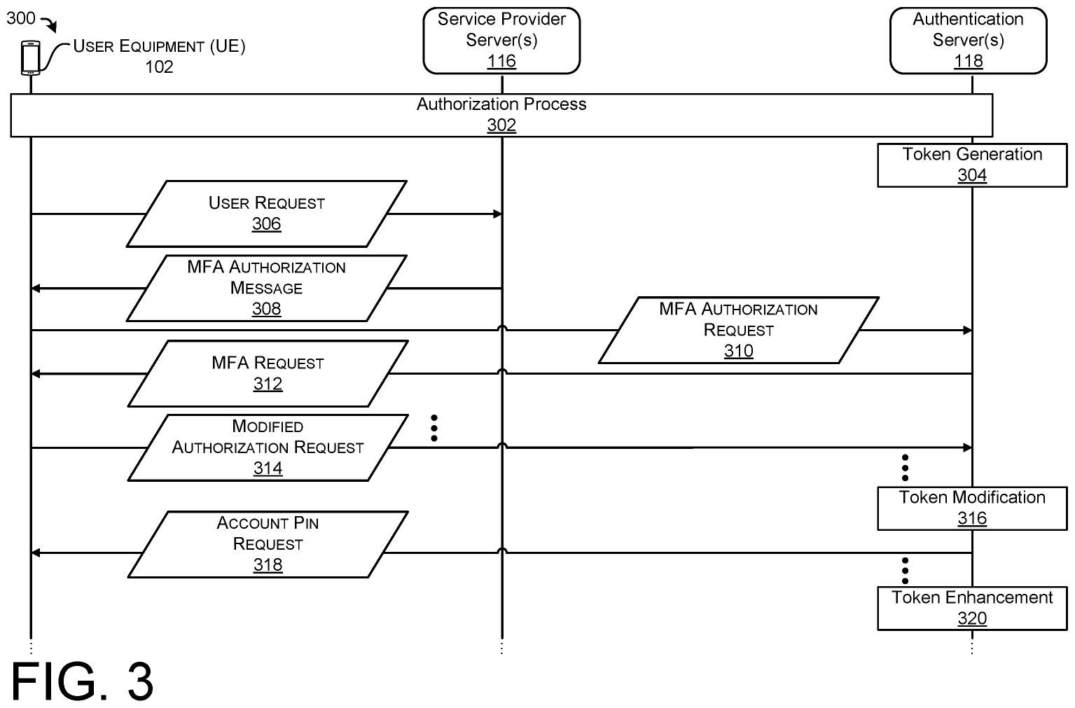

FIG. 3 is a diagram illustrating example signaling 300 for generating a token that represents an authentication of credential information, an authentication of a one-time password (OTP), and an authentication of a billing account pin. The example signaling 300 may include signaling between a user equipment (UE) (e.g., the user equipment 102, as discussed above with reference to FIG. 1), one or more service provider servers (e.g., the service provider server(s) 116, as discussed above with reference to FIG. 1), and one or more authentication servers (e.g., the authentication server 118, as discussed above with reference to FIG. 1).

The user equipment 102, the service provider server(s) 116, and the authentication server(s) 118 can perform an authorization process 302. The authorization process 302 can include the user equipment 102 transmitting an authorization request and receiving an authorization code message, in a similar way as for the authorization request 202 and the authorization code message 204, respectively, as discussed above with reference to FIG. 2. The authorization process 302 can include the user equipment 102 transmitting an authorization code relay, and the service provider server(s) 116 transmitting a token request, in a similar way as for authorization code relay 206 and the token request 208, respectively, as discussed above with reference to FIG. 2.

The authentication server(s) 118 can perform a token generation 304. The token generation 304 can be performed based on an authorization code message, an authorization code relay, and a token request, in a similar way as for the token generation 210, as discussed above with reference to FIG. 2. The authentication server(s) 118 can transmit the access token, which can be signed by the authentication server(s) 118, to the service provider server(s) 116

The user equipment 102 can transmit a request (or “user request”) 306 that is received and processed by the service provider server(s) 116. The user equipment 102 can determine to transmit, and transmit, the user request 306 in a similar way as for the user request 212, as discussed above with reference to FIG. 2. However, the user request 306 can be associated with an online/digital purchase, a user equipment purchase, an account management request, etc.

In some examples, the user request information in the user request 306 can include different types of information than the user request information (e.g., information associated with relatively minor requests) in the user request 212. In some examples, the purchase information (e.g., information associated with the online-digital purchase and/or the user equipment purchase) in the user request 306 can indicate one or more items being requested to be added to, or removed from, the account. The purchase information in the user request 306 can indicate the item(s) (e.g., a new phone) requested for purchase, and/or payment information (e.g., a credit card being added to the account, a credit card that was previously added to the account and stored with the service provider, etc.) utilized to purchase the item(s). The payment information can include full payment information, equipment installment plan (EIP) information, and the like.

In some examples, the service plan information (e.g., information associated with the account management request) in the user request 306 can include information indicating changes requested for the service plan (e.g., a temporary international plan, an increase in a service plan, etc.). The account information in the user request 306 can include information indicating changes requested for the account (e.g., a requested change of an account owner, a primary account holder (PAH) of the account, a name and/or an address associated with the account, etc.).

The service provider server(s) 116 may receive and process the user request 306 in a similar way as for the user request 202, as discussed above with reference to FIG. 2. However, the service provider server(s) 116 can determine that validation of an MFA element (e.g., a 2FA element) (e.g., a biometrics data element, a one-time password (OTP), etc.) is required, based on the user request 306, and/or the user request information in the user request 306, being associated with a rule (e.g., a service provider rule and/or a third-party rule). The service provider rule and/or the third-party rule can be utilized to determine that validation of the MFA is required based on the user request 306, in comparison to the MFA not being required based on the user request 202. The service provider rule and/or the third-party rule can be based on differences between the user request 306 (e.g., the user request information in the user request 306) and the user request 212 (e.g., user request information in the user request 212).

The different levels of security associated with account data access, and purchase transactions associated with different service provider and/or third-party rules, provide customized security protection. A potential severity of harm due to fraudulent acts by bad actors that are able to cause processes associated with the request 202 to be performed may be less than a potential severity of harm due to fraudulent acts by bad actors that are able to cause processes associated with the user request 306 to be performed. Refraining from requiring validation of the MFA element and the account pin unless the user request 306 is received, in comparison to the user request 202, provides an increased level of security for users to cause processes associated with the user request 306 to be performed. A user is only required to provide both the MFA element and the account pin to cause processes associated with the request 306 to be performed.

The service provider server(s) 116 can transmit an MFA authorization message (or “MFA authorization required message”) 308 to the user equipment 102. The MFA authorization message 308 can be utilized by the user equipment 102 to determine whether to request MFA (e.g., MFA authorization). By way of example, the MFA authorization message 308 can indicate to the user equipment 102 that MFA is required for processing the user request 212. The service provider server(s) 116 can transmit the MFA authorization message 308 based on determining the token is not modified. The service provider server(s) 116 can determine processing of the user request 306 requires the modified token.

The user equipment 102 can transmit an MFA authorization request (“authorization step-up request”) (or “device verification authorization request”) 310 to the authentication server 118. The user equipment 102 can include authorization parameters, indicating that MFA (e.g., 2FA) is required.

The authentication server(s) 118 can determine one or more MFA (e.g., 2FA) elements (e.g. SMS OTP, email OTP, Security Questions, Biometrics, push notifications) available for modifying (or “stepping-up”) authentication of the access token. The MFA element(s) associated with one or more of the MFA types) may be utilized by the user equipment 102.

The authentication server(s) 118 can transmit an MFA request (or “device verification request”) 312 to the user equipment 102, which can utilize the MFA element to authenticate the authentication request 202. The MFA request 312 can be transmitted to the user equipment 102, for example, based on the user equipment 102 being a registered device of the user. The MFA request 312 can be utilized by the user equipment 102 to request, from the user, selection of one or more MFA types from among the MFA types. For instance, with examples in which the user equipment 102 outputs information requesting user input associated an MFA type, user input indicating one or more selections received via the user equipment 102 is received. By way of example, the selection(s) can indicate an SMS OTP as a selected MFA type.

The user equipment 102 can transmit, to the authentication server 118, an MFA response indicating the selected MFA element(s) (e.g., the SMS OTP). The authentication server 118 can transmit, and the user equipment 102 can receive, the SMS with the OTP (e.g. a 6 digit code).

The user equipment 102 can transmit data (e.g., the OTP) (or “device verification data”) to the authentication server 118, via a modified authorization request 314. The data (e.g., the OTP) can be transmitted by the user equipment 102, based on the OTP being received by the user equipment 102 via user input indicating one or more selections.

Although the SMS message can be utilized to transmit the OTP, as discussed above in this disclosure, it is not limited as such. Any type of technology can be utilized instead of the SMS message to transmit other MFA (e.g., 2FA) authentication credential information and can be implemented for any of the techniques as discussed herein. Any of one or more types of MFA (e.g., 2FA) types (e.g., MFA security credential(s)) can be utilized instead of the OTP, and can be implemented in a similar way as for the OTP for any of the techniques as discussed herein.

The authentication server 118 can verify the access token generated via the token generation 304, authorization context, and the MFA (e.g., 2FA) security credential (e.g., the OTP) received in the modified authorization request 314. The modified authorization request 314 can include one or more of any of the authorization parameter(s) provided by the user equipment 102, and the MFA security credential(s). The authentication server 118 can determine the modified authorization request 314 is valid, in a similar way as for determining the authorization request 202 is valid, as discussed above with reference to FIG. 2, except by utilizing the access token as well as the MFA security credential(s). The authentication server 118 can generate an authorization code (or “modified authorization code”), based on the modified authorization request 314 being valid.

The authentication server 118 can transmit, to the user equipment 102, a modified authorization code message, based on the modified authorization request 314 being valid. The modified authorization code can be sent in the modified authorization code message. The user equipment 102 can transmit, to the service provider server(s) 116, a modified authorization code relay, based on the modified authorization code message. The modified authorization code message can be processed by the user equipment 102, and the modified authorization code relay can be processed by the service provider server(s) 116, in a similar way as for the authorization code message and the authorization code relay, respectively, as discussed above.

The user equipment 102 can forward, in the modified authorization code relay, the modified authorization code to the service provider server(s) 116, possibly as part of an HTTP redirect. The service provider server(s) 116 can transmit, based on the modified authorization code relay, a modified token request (or “token modification request”), in a similar way as for the token request 208. The modified token request including the modified authorization code can be transmitted by the service provider server(s) 116, based on the modified authorization code being validated by the service provider server(s) 116.

The authentication server 118 can perform a modified token generation process (or “token modification”) 316. The token modification 316 can be performed based on the modified authorization code. The modified authorization code can be received, from the service provider server(s) 116, in the modified token request, in a similar way as for the authorization code being received in the token request 208, as discussed above with reference to FIG. 2. The modified authorization code in the modified token request can be utilized to generate a modified token, via the token modification 316.

The modified token can include one or more data parameters (or “authorization parameter(s)”) indicating the user identity, user authentication information (e.g., the user identity elements utilized to authenticate the user), MFA (e.g., 2FA) authentication information (e.g., the MFA element(s) utilized to verify the user device), the level of user authorization and billing account authorization, and security parameters related to the authentication and authorization of the user. The user authentication information can indicate the type(s) of user authentication utilized for generating the modified token. The MFA information can indicate the type(s) of MFA utilized for generating the modified token. The modified token can be signed by the authentication server(s) 118 for security. The level of user and billing account authorization can be associated with the user request 306.

The modified token can be generated based on the access token and the MFA security credential(s) (e.g., the MFA element(s)) being validated. The authentication server(s) 118 can transmit the modified token to the service provider server(s) 116.

The authentication server(s) 118 can transmit a request (or “account pin request”) 318 to the user equipment 102. The account pin request 318 can be transmitted to, and processed by, the user equipment 102 in a similar way as for the account pin request 218. The account pin request 318 can be transmitted based on a billing account authorization request received from the user equipment 102. The billing account authorization request can include one or more of the authorization parameters associated with the token generated via the token modification 316.

The user equipment 102 can transmit an enhanced authorization request (or “billing account pin response”) to the authentication server(s) 118, which can be utilized by the authentication server(s) 118 to generate an enhanced authorization code. The enhanced authorization request can include the billing account pin received by the user equipment 102 via input from the user. The enhanced authorization request can be processed by the authentication server(s) 118, in a similar way as for the enhanced authorization request 220, as discussed above with reference to FIG. 2. The enhanced authorization request can be utilized by the authentication server(s) 118 to transmit an enhanced authorization code message to the user equipment 102.

The enhanced authorization code message can be processed by the user equipment 102, and utilized to transmit an enhanced authorization code relay, in a similar way as the enhanced authorization code message and the enhanced authorization code relay, respectively, as discussed above with reference to FIG. 2. The user equipment 102 can forward, in the enhanced authorization code relay, the enhanced authorization code to the service provider server(s) 116, possibly as part of an HTTP redirect. The service provider server(s) 116 can transmit an enhanced token request (or “token enhancement request”)), in a similar way as for the enhanced token request, as discussed above with reference to FIG. 2.

The authentication server(s) 118 can perform an enhanced token generation process (or “token enhancement”) 320, based on the enhanced token request. The token enhancement 320 can be performed to generate the enhanced token 148 (e.g., a token 148 of a second type), in a similar way as the token enhancement 222, as discussed above with reference to FIG. 2, except by utilizing the modified token generated via the token modification 316. The authentication server(s) 118 can transmit the token 148, which can be signed by the authentication server(s) 118, to the service provider server(s) 116. The token enhancement 222 can be performed based on the modified token and the account pin being validated. In some examples, the token enhancement 222 can be performed to enhance the modified token generated via the token modification 316.

In some examples, the authentication server(s) 118 can transmit a response (or “invalid authorization response”) based on the corresponding data (e.g., element(s)) in any of the token request, the modified token request, and/or the enhanced token request not being validated. The invalid authorization data response can be utilized by the user equipment 102 to output information to indicate the corresponding element(s) not being validated, and to transmit new data. The corresponding updated request(s) can be processed in a similar way as the invalid request(s). The process can continue until the enhanced token 148 is generated.

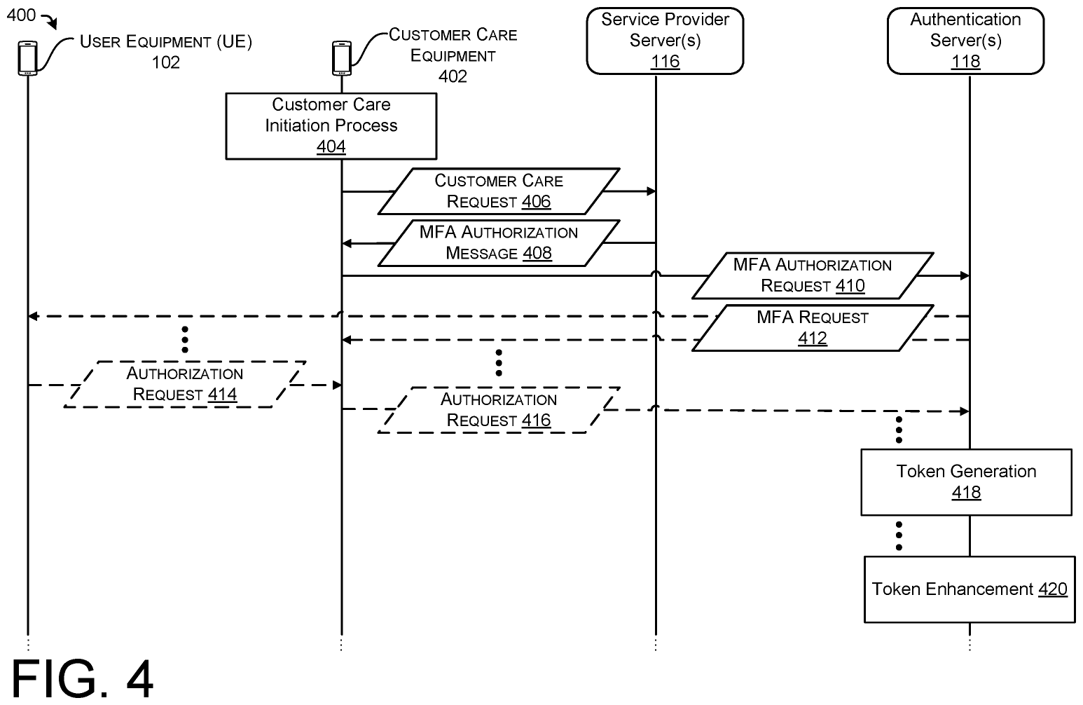

FIG. 4 is a diagram illustrating example signaling 400 for generating a token that represents an authentication of a one-time password (OTP), and an authentication of a billing account pin. The example signaling 400 may include signaling between a user equipment (UE) (e.g., the user equipment 102, as discussed above with reference to FIG. 1), a customer care equipment 402, one or more service provider servers (e.g., the service provider server(s) 116, as discussed above with reference to FIG. 1), and one or more authentication servers (e.g., the authentication server 118, as discussed above with reference to FIG. 1). The customer care equipment 402 can be implemented in a similar way as the user equipment 102, as discussed above with reference to FIG. 1.

The customer care equipment (or “customer care device”) 402 can perform a customer care initiation process 404 associated with a customer care agent (e.g., a customer care representative of the customer care equipment 402). The customer care initiation process 404 can include the customer care agent receiving information from the customer (e.g., the user of the user equipment 102, or any other user), based on a discussion (e.g., a telephone call discussion) between the customer and the customer care agent.

The information received from the customer can include an initial customer care request (e.g. a mobile equipment upgrade or billing plan change) associated with the customer and/or the user account. The customer care equipment 402 can be utilized to input and process the information received from the customer, based on customer agent input via one or more selections received by the customer care equipment 402. The information indicated via the selection(s) received by the customer care equipment 402 can include information associated with the initial customer care request, and/or one or more of information (e.g., the user identity data and/or security credentials, as discussed above with reference to FIG. 1) associated with the customer and/or the user account.

The customer care equipment 402 can transmit a customer care request 406 to the service provider server(s) 116, via the network(s) 114. The customer care request 406 can be transmitted, based on the customer care initiation process 404 (e.g., the information received from the customer during the telephone call). The customer care request 406 can be transmitted based on user input via one or more selections received by the customer care equipment 402. The customer care request 406 can include data (or “customer care request data”), including one or more portions of the user identity data and/or one or more of the security credential(s) (or “authorization parameter(s)) (e.g., security credential(s) provided by the customer via the telephone call with the customer care agent) associated with the customer (e.g., the user of the user equipment 102) and/or the user account.

The customer care request 406 can include data (or “customer care request data”) utilized by the service provider server(s) 116 to determine to perform a multi-factor authentication (MFA) process (or “MFA”) (e.g., a second factor authentication (2FA)) element validation process (or “2FA authentication”). The MFA can be utilized to request security credential(s) from the customer care equipment 402. The security credential(s) can include one or more of passwords (or “user passwords”), answers to security questions, and multi factor authentication (MFA) elements (e.g., biometrics data elements, one-time passwords (OTPs), etc.)). The service provider server(s) 116 can receive, in the customer care request 406 and via the network(s) 114, the data indicating the request to perform the MFA. The customer care request 406 indicating the request to perform the MFA can be transmitted to allow the customer care agent to verify the user (e.g., the customer) speaking with the customer care agent is an authorized user of the user equipment 102.

The service provider server(s) 116 can transmit an MFA authorization message (or “MFA authorization required message”) 408 to the user equipment 102. The MFA authorization message 408 can be transmitted to, and processed by, the user equipment 102 in a similar way as for the MFA authorization message 308 utilized by the user equipment 102 to determine whether to request MFA (e.g., MFA authorization).

The user equipment 102 can transmit an MFA authorization request 410 to the authentication server 118. The MFA authorization request 410 can be transmitted based on the MFA authorization message 408. The authentication server 118 can process the MFA authorization request 410, in a similar way as for the MFA authorization request 310, as discussed above with respect to FIG. 3.

The authentication server 118 can transmit an MFA request 412 to the user equipment 102 and/or the customer care equipment 402. The user equipment 102 and/or the customer care equipment 402 can process the MFA request 412 in a similar way as the MFA request 312, as discussed above with respect to FIG. 3.

For instance, with examples in which the MFA request 412 is transmitted to the customer care equipment 402, the customer care equipment 402 can receive MFA selection information (or a “selected MFA element”) (e.g., information indicating one or more MFA elements) via one or more selections received by the customer care equipment 402. In those examples, the MFA selection information can be received by the customer care equipment 402, based on information (e.g., the MFA selection information) provided by the customer and to the customer care representative, via the telephone call.

For instance, with examples in which the MFA request 412 is transmitted to the user equipment 102, the user equipment 102 can receive MFA selection information (or a “selected MFA element”) (e.g., information indicating one or more MFA elements) via one or more selections received by the user equipment 102. In those examples, the user equipment 102 can receive a message from the customer care equipment 402 requesting the MFA selection information, based on the customer care representative controlling the customer care equipment 402 to transmit the message to the user equipment 102, such as by one or more communication programs (e.g., chat program(s), an email program(s), etc.). The MFA selection information can be transmitted by the user equipment 102 and to the customer care equipment 402, based on information (e.g., the MFA selection information) being transmitted by the user equipment 102 and to the customer care equipment 402, such as by the communication program(s).

In some examples, the user equipment 102 and/or the customer care equipment 402 can transmit an MFA response indicating the selected MFA element (e.g., a short message service (SMS) one-time password (OTP)). The authentication server 118 can generate and transmit, to the user equipment 102 and/or the customer care equipment 402, the selected MFA element (e.g., the SMS OTP (e.g. a 6 digit code)).

The user equipment 102 and/or the customer care equipment 402 can transmit data (e.g., the OTP) to the authentication server 118, via an authorization request 414 and/or an authorization request 416, respectively. The authorization request 414 and/or the authorization request 416 can be processed by the authentication server 118, in a similar way as the modified authorization request 312, as discussed above with reference to FIG. 3. The authorization request 414 and/or the authorization request 416 can include the MFA element. For instances in which the authorization request 414 is transmitted by the user equipment 102, information in the authorization request 414 can, in some examples, be forwarded, in the authorization request 414 and by the customer care equipment 402, to the authentication server 118. In other examples, the information in the authorization request 414 can be transmitted in the authorization request 414, by the user equipment 102 and to the authentication server 118.

For instance, with examples in which the authorization request 416 is received from the customer care equipment 402, the customer care equipment 402 can receive the MFA element (e.g., the OTP), as the selected MFA element, via one or more selections received by the customer care equipment 402. In those examples, the selected MFA element (e.g., the SMS) can be received by the by the customer care equipment 402, based on information (e.g., the selected MFA element (e.g., the SMS) being provided by the user and to the customer care representative, via the telephone call.

For instance, with examples in which the authorization request 414 is received from the user equipment 102, the user equipment 102 can receive the MFA element (e.g., the OTP), as the selected MFA element, via one or more selections received by the user equipment 102. In those examples, the user equipment 102 can receive a message from the customer care equipment 402 requesting the MFA element, based on the customer care representative controlling the customer care equipment 402 to transmit the message to the user equipment 102, such as by one or more communication programs (e.g., chat program(s), an email program(s), etc.).

The selected MFA element (e.g., the SMS) can be transmitted by the user equipment 102 and to the customer care equipment 402, such as by the communication program(s). The selected MFA element that is received in the authorization request 414 can be transmitted, by the customer care equipment 402 and to the authentication server 118. In some examples, the selected MFA element (e.g., the SMS) can be transmitted by the user equipment 102 and to the authentication server 118.

In some examples, the MFA element that is generated by the authentication server 118 can be utilized to determine that the authorization request 414 and/or the authorization request 416 is valid. In some examples, the MFA element and the customer care request data can be utilized to process the authorization request 414 and/or the authorization request 416. In those examples, the MFA element that is generated by the authentication server 118, and the customer care request data, can be utilized to determine that the authorization request 414 and/or the authorization request 416 is valid.

The authentication server 118 can generate an authorization code, based on the authorization request 414 and/or the authorization request 416 being valid. The authentication server 118 can perform a token generation 418 based on an authorization code message, an authorization code relay, and a token request, in a similar way as for the token generation 304, as discussed above with reference to FIG. 3, except by utilizing the MFA element and the customer care request data.

The authentication server 118 can perform a token enhancement 420 to generate an enhanced token (e.g., a token 148) (e.g., a token 148 of a third type). The token enhancement 420 can be performed based on an account pin request, an enhanced authorization request, an enhanced authorization code message, an enhanced authorization code relay, and an enhanced token request, in a similar way as for the token enhancement 320, as discussed above with reference to FIG. 3. The token generation 418 can be performed based on the billing account pin being received, in the enhanced authorization request, and from the user equipment 102 and/or the customer care equipment 402.

The customer care equipment 402 and/or the user equipment 102 being utilized to receive the account pin request and transmit the enhanced authorization request can be determined based on customer care agent input (e.g., input based on instructions received from the customer during the in-person discussion) via one or more selections received by the customer care equipment 402. In some examples, the enhanced authorization code message can be transmitted by, and the enhanced authorization code relay can be received from, the user equipment 102. Alternatively or additionally, the enhanced authorization code message can be transmitted by, and the enhanced authorization code relay can be received from, the customer care equipment 402.

For instance, with examples in which the account pin request is transmitted to the customer care equipment 402, the customer care equipment 402 can receive data (e.g., the billing account pin) via one or more selections received by the customer care equipment 402. In those examples, the billing account pin can be received by the customer care equipment 402, based on information (e.g., the billing account pin) provided by the user and to the customer care representative, via the telephone call.

For instance, with examples in which the account pin request is transmitted to the user equipment 102, the user equipment 102 can receive data (e.g., the billing account pin) via one or more selections received by the user equipment 102. In those examples, the user equipment 102 can receive a message from the customer care equipment 402 requesting the billing account pin, based on the customer care representative controlling the customer care equipment 402 to transmit the message to the user equipment 102, such as by one or more communication programs (e.g., chat program(s), an email program(s), etc.). The billing account pin can be transmitted by the user equipment 102 and to the customer care equipment 402, such as by the communication program(s).

The token 148 generated based on the customer care initiation process 404 and the customer care request 406 can include one or more data parameters indicating the user identity, user authentication (e.g., the user identity elements utilized to authenticate the user) (e.g. SMS OTP), the level of user and billing account authorization, information (e.g., a name, a care representative identifier, etc.) about the care representative, the billing account identifier (ID), the level of billing account authorization, and security parameters related to the authentication and authorization of the user. The token 148 can be signed by the authentication server 118 for security. The user authentication information can indicate the type(s) of user authentication utilized for generating the modified token. The level of user and billing account authorization can be associated with the customer care request 406.

In some examples, the token 148 generated based on the customer care initiation process 404 and the customer care request 406 can be utilized by the service provider server(s) 116 to perform various processes (e.g., allow one or more purchase transactions). In those examples, the token 148 generated based on the customer care initiation process 404 and the customer care request 406 can be utilized to allow any number and/or combination of the purchase transaction(s) associated with a same session. The purchase transaction(s) can be associated with the service provider and/or the third-party. The token 148 generated based on the customer care initiation process 404 and the customer care request 406 can be utilized to perform (e.g., allow) any functions in a similar way as for any of the tokens 148, as discussed above with respect to FIGS. 1 and 2.

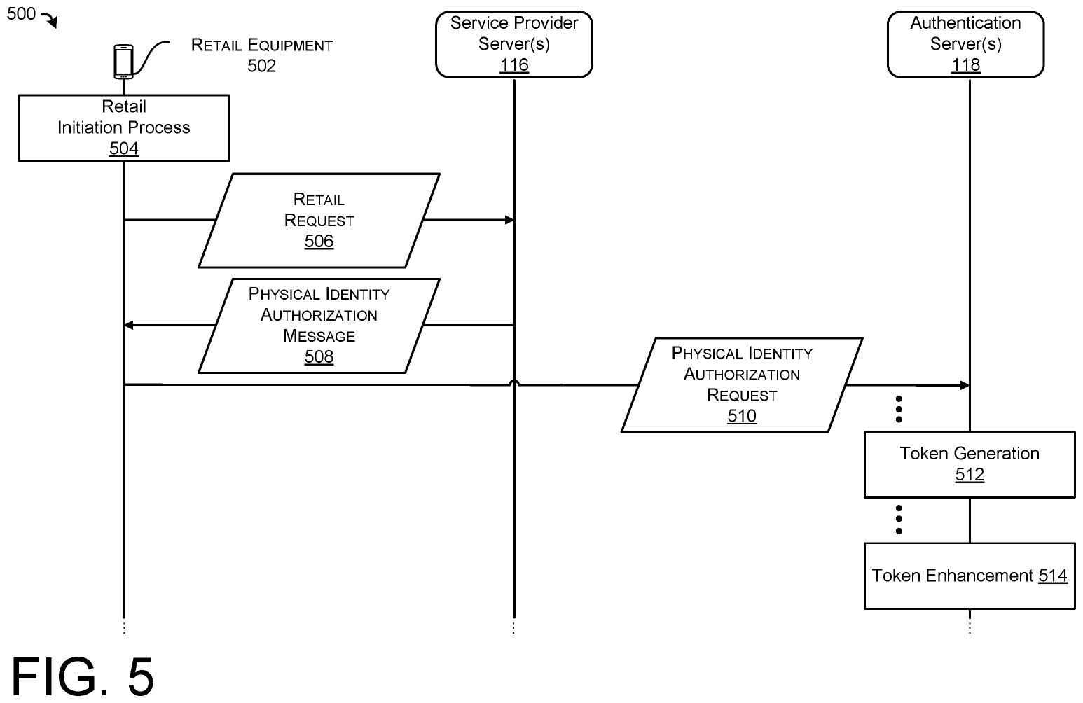

FIG. 5 is a diagram illustrating example signaling 500 for generating a token that represents an identification inspection, and an authentication of a billing account pin. The example signaling 500 may include signaling between a user equipment (UE) (e.g., the user equipment 102, as discussed above with reference to FIG. 1), a retail equipment 502, one or more service provider servers (e.g., the service provider server(s) 116, as discussed above with reference to FIG. 1), and one or more authentication servers (e.g., the authentication server 118, as discussed above with reference to FIG. 1). The retail equipment 502 can be implemented in a similar way as the user equipment 102, as discussed above with reference to FIG. 1.

The retail equipment 502 can perform a retail initiation process 504 associated with a retail agent (e.g., a retail representative of the retail equipment 502). The retail initiation process 504 can include the retail agent receiving information from the customer (e.g., the user of the user equipment 102, or any other user), based on a discussion (e.g., in-person discussion) between the customer and the retail agent. The customer and the retail agent may be at a retail location (e.g., a retail store (e.g., a brick and mortar store)). The information received from the customer can include an initial retail request (e.g. a mobile equipment upgrade or billing plan change) associated with the customer and/or the user account. The retail equipment 502 can be utilized to process the information received from the customer and input to the retail equipment 502, based on retail agent input via one or more selections received by the retail equipment 502. The information indicated via the selection(s) received by the retail equipment 502 can include information associated with the initial retail request, and/or one or more of information (e.g., the user identity data and/or security credentials, as discussed above with reference to FIG. 1) associated with the customer and/or the user account.

The information received from the customer and input to the retail equipment 502, as part of the retail initiation process 504, can include information (e.g., physical identity validation data) (or “manual identity validation data”) based on the retail agent performing physical identity validation for the customer. In some examples, the physical identity validation data can be received by the retail equipment 502 based on the selection(s) received by the retail equipment 502. The physical identity validation data can be input to the retail equipment 502 and by the retail agent, based on the retail agent performing a physical identity validation of the customer (e.g., the user of the user equipment 102). The physical identity validation data can indicate successful physical validation of the information (e.g., the user identity data and/or security credentials, as discussed above with reference to FIG. 1) associated with the customer and/or the user account. In some examples, the physical identity validation can include visual inspection of a piece (or “one or more documents”) of identification (e.g., a driver's license, another form of government identification, or any other type of identification for verifying identity) of the user.

The retail equipment 502 can transmit a retail request 506 to the service provider server(s) 116, via the network(s) 114. The retail request 506 can be transmitted, based on the retail initiation process 504 (e.g., the information received from, and physically validated for, the customer during the in-person discussion). The retail request 506 can be transmitted based on user input via one or more selections received by the retail equipment 502. The retail request 506 can include the initial retail request. In some examples, the retail request 506 can include one or more authorization parameters provided by the customer via the discussion with the retail agent.

The service provider server(s) 116 can transmit a physical identity authorization message (or “physical identity authorization required message”) 508 to the user equipment 102. The physical identity authorization message 508 can be transmitted based on the service provider server(s) 116 determining that additional authorization (e.g., physical identity authorization) is required. The physical identity authorization message 508 can be transmitted to, and processed by, the user equipment 102 in a similar way as for the MFA authorization message 308. The physical identity authorization message 508 can be utilized by the user equipment 102 to determine whether to request additional authorization.

The user equipment 102 can transmit a physical identity authorization request 510 to the authentication server 118. The physical identity authorization request 510 can be transmitted based on the physical identity authorization message 508. The physical identity authorization request 510 can include data (or “retail request data”), including one or more portions of the user identity data and/or one or more of the security credential(s) (or the “authorization parameter(s)) (e.g., security credential(s) provided by the customer via the discussion with the retail agent) associated with the customer (e.g., the user of the user equipment 102) and/or the user account. The authentication server 118 can process the physical identity authorization request 510, in a similar way as for the MFA authorization request 310, as discussed above with respect to FIG. 3, except by utilizing the retail request data.

The authentication server 118 can generate an authorization code, based on the physical identity authorization request 510 being valid. The authentication server 118 can perform a token generation 512 (e.g., a token generation based on an authorization code message, an authorization code relay, and a token request), in a similar way as for the token generation 304, as discussed above with reference to FIG. 3, by utilizing the retail request data. In some examples, the token request can indicate the user identity and assertion of the validity of the physical identity.

The authentication server 118 can perform an enhanced token generation process (or “token enhancement”) 514 to generate an enhanced token (e.g., a token 148) (e.g., a token 148 of a fourth type). In some examples, the token enhancement 514 can be performed based on communications (e.g., an account pin request, an enhanced authorization code message, an enhanced authorization code relay, and an enhanced token request), in a similar way as for the token enhancement 420, as discussed above with reference to FIG. 4, except by utilizing communications between the authentication server 118 and the retail equipment 502 instead of between the authentication server 118 and the customer care equipment 402.

In some examples, the token enhancement 514 can include the authentication server 118 determining the billing account authorization is required. The retail agent can make a request to the customer based on the account pin request. In some examples, the request for the account pin from the customer can be made by the retail agent during the in-person discussion. Once the customer informs the retail agent of the billing account pin, the retail agent can provide, via input to the retail equipment 502 indicating one or more selections, the billing account pin to the retail equipment 502. The retail equipment 502 and/or the user equipment 102 can be utilized to receive the account pin request from, and transmit the enhanced authorization request to, the authentication server 118. based on retail agent input (e.g., input based on instructions received from the customer during the in-person discussion) via one or more selections received by the retail equipment 502.

The token 148 generated via based on the retail initiation process 504 and the retail request 506 can include data parameters indicating the user identity, one or more types of user authentication (e.g. physical identity), the level of user authorization, information (e.g., a name, a representative identifier, etc.) about the retail representative, the billing account ID, the level of billing account authorization, and security parameters related to the authentication and authorization of the user. The level of the billing account authorization can be associated with the retail request 506. The token generated based on the retail initiation process 504 and the retail request 506 can be signed by the authentication server 118 for security.

In some examples, the token 148 generated based on the retail initiation process 504 and the retail request 506 can be utilized by the service provider server(s) 116 to allow access to the user account and/or to perform various processes (e.g., allow one or more purchase transactions). In those examples, the token 148 generated based on the retail initiation process 504 and the retail request 506 can be utilized to allow any number and/or combination of the purchase transaction(s) associated with a same session. The purchase transaction(s) can be associated with the service provider and/or the third-party. The token 148 generated based on the retail initiation process 504 and the retail request 506 can be utilized to perform (e.g., allow) any functions in a similar way as for any of the tokens 148, as discussed above with respect to FIGS. 1 and 2.

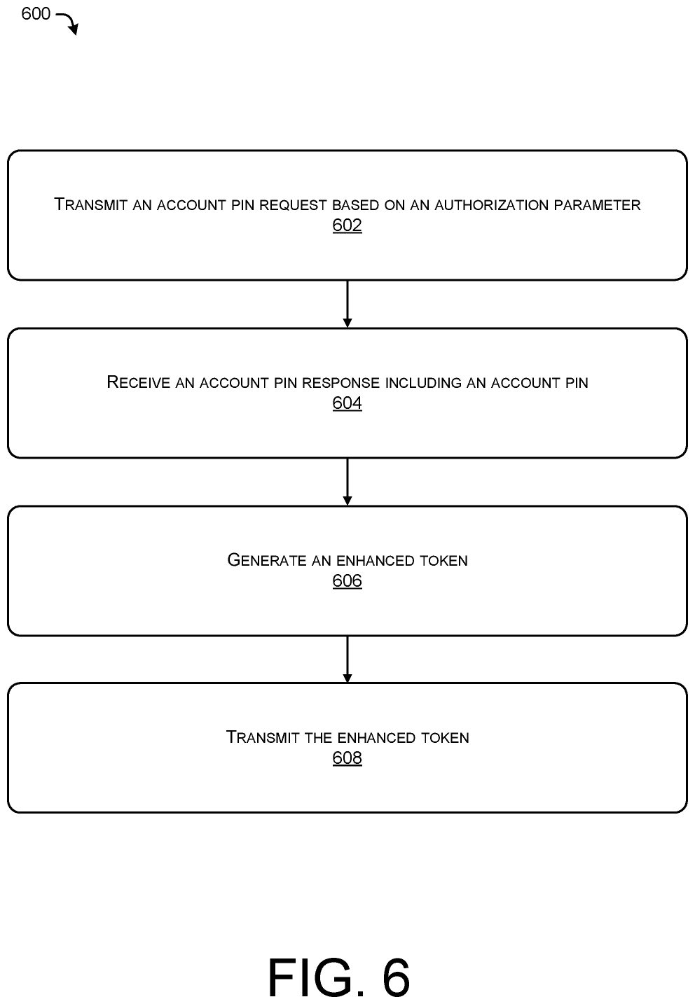

FIG. 6 illustrates a flowchart of an example process for generating a token that represents an authentication of a billing account pin. The example process 600 can be performed by one or more service provider servers (e.g., the service provider server(s) 116, or another component, in connection with other components discussed herein.

At operation 602, the process can include transmitting an account pin request 218 based on an authorization parameter. The authorization parameter can be included in an authentication token (e.g., the token generated via the token generation 210). The account pin request 218 can be transmitted based on the authentication server 118 receiving the authorization request 202 and generating the token indicating the security credential(s) being validated. In some examples, authentication server 118 can generate the token based on an authorization code in the token generation request 208, the authorization code indicating identification data in the authorization request 202 (e.g., the username and the password) being validated.

At operation 604, the process can include receiving an account pin response (e.g., an enhanced authorization request 220) including an account pin. The account pin response, which can be received from the user equipment 102, can include data based on the account pin request 218. The data may be received via one or more selections indicated by user input to the user equipment 102.

At operation 606, the process can include generating an enhanced token, via the token enhancement 222, based on the authorization parameter and the account pin being validated. The authentication server 118 can validate the data in the account pin response includes the account pin. The service authentication server 118 can validate the account pin is included in the account pin response, based on determining the received data (e.g., the account pin) matches an account pin 146 in the security data 144 associated with the user.

At operation 608, the process can include transmitting the enhanced authentication token 148 indicating that the account pin is associated with the authorized user. The service provider server(s) 116 can receive the enhanced authentication token that is generated by the authentication server 118. The enhanced authentication token can indicate the identification data in the authorization request 202 being validated, and can include an account identity attribute associated with the account pin being validated.

Other architectures can be used to implement the described functionality, and are intended to be within the scope of this disclosure. Furthermore, although specific distributions of responsibilities are defined above for purposes of discussion, the various functions and responsibilities might be distributed and divided in different ways, depending on circumstances.

Similarly, software can be stored and distributed in various ways and using different means, and the particular software storage and execution configurations described above can be varied in many different ways. Thus, software implementing the techniques described above can be distributed on various types of computer-readable media, not limited to the forms of memory that are specifically described.

1. A network node of a telecommunications network, the network node comprising:
a processor; and
memory storing computer-executable instructions that, when executed by the processor, cause the network node to:
receive a billing account authorization request indicating billing account authorization is required, the billing account authorization request including an authorization parameter;
transmit, to a user device, a billing account pin request;
receive, from the user device, a billing account pin response including a billing account pin that is a telecommunications billing account pin;
validate the billing account pin as being associated with an authorized user, the authorized user being a user of a billing account;
generate an enhanced token based on the authorization parameter and the billing account pin being validated; and
transmit the enhanced token indicating that the user is authorized for the billing account, to allow a purchase transaction to be processed based on the enhanced token.

2. The network node of claim 1, wherein the enhanced token includes a billing account attribute indicating the billing account pin is associated with the authorized user.

3. The network node of claim 1, wherein validation of the authorization parameter is utilized to generate an authorization code, and validation of the authorization code is utilized to generate an authentication token, the instructions further causing the network node to:
generate an enhanced authorization code based on the authentication token and the billing account pin being validated,
wherein the enhanced token is generated based on an enhanced token request, the enhanced token request including the enhanced authorization code.

4. The network node of claim 1, wherein the authorization parameter is included in a user authentication token generated based on an authorization request, the instructions further causing the network node to:
receive a device verification authorization request;
transmit a device verification request;
receive device verification data in a modified authorization request; and
generate a modified token based on the modified authorization request,
wherein the enhanced token is generated based on the modified token and the billing account pin being validated.

5. The network node of claim 1, the instructions further causing the network node to:
receive a user request;
validate a security credential associated with the user; and
generate an authentication token based on the security credential being validated,
wherein the authentication token is included in the billing account authorization request, and utilized to generate the enhanced token to authorize the user request.

6. The network node of claim 1, wherein:
the authorization parameter is included in retail request data, and
the enhanced token is generated based on the retail request data.

7. The network node of claim 1, wherein:
the authorization parameter is included in customer care request data, and
the enhanced token is generated based on the customer care request data.

8. The network node of claim 1, wherein:
the authorization parameter is utilized to generate a user authentication token;
the user authentication token and a device verification code are utilized to generate a modified token; and
the enhanced token is generated based on the modified token.

9. The network node of claim 1, wherein:
the authorization parameter is included in customer care request data;
the customer care request data and device verification data are utilized to generate a user authentication token; and
the enhanced token is generated based on the user authentication token.

10. The network node of claim 1, the instructions further causing the network node to:
receive an authorization request utilized to generate a token including the authorization parameter; and
receive an enhanced authorization request based on the billing account pin request,
wherein the enhanced authorization request is validated and utilized to generate the enhanced token.

11. A system, comprising:
one or more processors;
one or more non-transitory computer-readable media storing computer-executable instructions that, when executed on the one or more processors, cause the one or more processors to perform actions comprising:
transmit an account pin request based at least in part on an authorization parameter;
receive an account pin response including an account pin that is a telecommunications account pin;
generate an enhanced token based at least in part on the authorization parameter and account pin being validated; and
transmit the enhanced token indicating that a user is authorized for a billing account.

12. The system of claim 11, wherein the enhanced token includes an account attribute indicating the account pin is associated with the user.

13. The system of claim 11, wherein validation of the authorization parameter is utilized to generate an authorization code, and validation of the authorization code is utilized to generate an authentication token, the instructions further causing the one or more processors to:
generate an enhanced authorization code based at least in part on the authentication token and the account pin being validated,
wherein the enhanced token is generated based at least in part on an enhanced token request, the enhanced token request including the enhanced authorization code.

14. The system of claim 11, wherein the authorization parameter is included in a user authentication token generated based on an authorization request, the instructions further causing the one or more processors to:
receive a device verification purchase request;
transmit a device verification request;
receive device verification data in a modified authorization request; and
generate a modified token based on the modified authorization request,
wherein the enhanced token is generated based at least in part on the modified token and the account pin being validated.

15. The system of claim 11, the instructions further causing the one or more processors to:
receive a user request;
validate a security credential associated with the user; and
generate an authentication token based on the security credential being validated,
wherein the authentication token is utilized to generate the enhanced token to authorize the user request.

16. A method comprising:
transmitting an account pin request based at least in part on an authorization parameter;
receiving an account pin response including an account pin that is a telecommunications account pin;
generating an enhanced token based at least in part on the authorization parameter and account pin being validated; and
transmitting the enhanced token indicating that a user is authorized for a billing account.

17. (canceled)

18. The method of claim 16, wherein validation of the authorization parameter is utilized to generate an authorization code, and validation of the authorization code is utilized to generate an authentication token, further comprising:
generating an enhanced authorization code based at least in part on the authentication token and the account pin being validated,
wherein the enhanced token is generated based at least in part on an enhanced token request, the enhanced token request including the enhanced authorization code.

19. The method of claim 16, wherein the authorization parameter is included in a user authentication token generated based on an authorization request, further comprising:
receiving a device verification purchase request;
transmitting a device verification request;
receiving device verification data in a modified authorization request; and
generating a modified token based on the modified authorization request,
wherein the enhanced token is generated based at least in part on the modified token and the account pin being validated.

20. The method of claim 16, further comprising:
receiving a user request;
validating a security credential associated with the user; and
generating an authentication token based on the security credential being validated,
wherein the authentication token is utilized to generate the enhanced token to authorize the user request.

21. The network node of claim 1, wherein the billing account is provided by a telecommunications service provider.
